(19) United States
(12) Patent Application Publication
(10) Pub. No.: US 2026/0103609 A1
(43) Pub. Date: Apr. 16, 2026

(54) METHOD FOR CONSTRUCTING A COVERING OF A SUBSTRATE AND COMPOSITE MATERIAL COMPRISING THAT COVERING

(71) Applicants: FONDAZIONE ISTITUTO ITALIANO DI TECNOLOGIA, Genova (GE) (IT); UNIVERSITA' DEGLI STUDI DI GENOVA, Genova (GE) (IT)

(72) Inventors: Giovanni Perotto, Genova (IT); Marta Fadda, Genova (IT); Arkadiusz Zych, Genova (IT); Athanasia Athanasiou, Ceranesi (GE) (IT)

(21) Appl. No.: 19/114,163

(22) PCT Filed: Sep. 26, 2023
(86) PCT No.: PCT/IB2023/059536

§ 371 Date: Mar. 21, 2025

(30) Foreign Application Priority Data
Sep. 26, 2022 (IT) 102022000019740

(51) Int. Cl. C09D 5/16; C08G 59/32; C09D 163/00

(52) U.S. Cl. CPC C09D 5/1662; C08G 59/32; C09D 163/00

(57) ABSTRACT

A method for making a composite material comprising at least one substrate and a covering layer applied to the substrate comprises the following steps: —providing a substrate containing a plurality of functional groups which are selected from a group comprising a carboxyl group (—COOH), amino group (—NH2), thiol group (—RSH), hydroxyl group (—OH) or a combination thereof,—mixing approximately from 30 to 70% by weight of a first compound with from 70 to 30% by weight of a second compound until obtaining a first homogeneous solution of said first compound and said second compound,—wherein said first compound is an epoxidized compound comprising at least 1.5 epoxide groups per molecule,—said second compound comprises a polyfunctional compound, preferably a bifunctional or trifunctional compound, preferably selected from a group comprising bifunctional carboxylic acids, trifunctional carboxylic acids, a plurality of carboxylic acids having at least 2 or 3 carboxyl groups, dimer carboxylic acids, trimer carboxylic acids, polyfunctional amines, diamines, triamines or admixtures thereof, applying said first solution to said substrate, subjecting said substrate to for a time period of at least approximately 30 minutes a drying step in order to dry said substrate which is provided with said first solution; subjecting said substrate to a cross-linking step in order to cross-link the substrate by maintaining said substrate at a temperature between approximately 50° C. and approximately 90° C., preferably between approximately 75° C. and approximately 80° C., for such a cross-linking time as to cause an opening reaction of at least a portion of the epoxide groups of said first compound in order to form a bond between said first compound with said second compound and said substrate in the region of at least some of the functional groups of said second compound and said substrate and a bond between said first compound and said substrate in the region of at least some of the functional groups of said substrate.

The present invention relates to a method for producing a covering of a substrate and a composite material comprising that covering. The invention finds preferred, though not exclusive, use in the production of a hydrophobic, waterproof covering, particularly suitable for covering collagen-containing substrates, such as natural leathers or hides, or substrates of plant origin or composed of plant fibres, preferably cotton.

The invention also finds preferred, though not exclusive, application in the production of a fish leather covering and a composite material comprising fish leather and a covering layer. The invention relates preferably, though not exclusively, to a composite material comprising salmon leather and a covering applied to that salmon leather. Therefore, reference will be made below to this sector without losing its generality.

In various technical fields, the need to coat products is particularly felt, for example in the packaging sector and in particular in the production of food packaging, for various reasons, e.g. the need to increase the durability of the product in question, to maintain the product's conditions as unaltered as possible over time, etc.

The treatment of substrates of various kinds by applying a waterproof covering to achieve a moisture-resistant product is also well known.

Also widespread in the fashion industry is the use of protective coverings to be applied to various materials that are intended to protect the materials to which they are applied in order to extend the life of the product obtained, or that are suitable for giving the materials to which they are applied desired properties such as waterproofing, water repellency, breathability, etc.

In particular, in the fashion industry the use of coverings that can make the substrate to which they are applied waterproof and/or increase its resistance to water penetration is known.

A shortcoming of known coverings is that they often have a limited life span, especially some properties of the coverings used tend to diminish considerably over time. This means, for example, that the impermeability of the covered material is reduced over time.

A further shortcoming of some known coverings is that they tend to separate from the substrate to which they are applied, causing a deterioration of the product's properties.

A further shortcoming of known coverings is that they are made from polluting products with a high environmental impact, such as petroleum-based products.

Furthermore, the methods for producing such coverings and applying them to the chosen substrate often involve the use of reagents with a high environmental impact and/or require energy-intensive or environmentally demanding conditions. Moreover, most of the materials used to make the coverings are not environmentally sustainable.

Instead, a need has arisen to provide coverings made of environmentally sustainable and ecological materials with low environmental impact, avoiding the use of petroleum-based materials. There is, however, a need to provide processes for producing coverings that do not involve reagents, or raw materials, with a high environmental impact and that can be easily implemented. There is also a need to limit the energy expenditure associated with the processes for preparing coverings.

This need is particularly perceived in the fashion industry, where more sustainable raw materials and processes are currently being pursued.

In the fashion industry, in particular, there is also a clear need to use substrates with limited environmental impact, e.g. to eliminate petroleum-derived materials.

Another requirement of the fashion industry is to limit the use of raw materials with high environmental impact, such as certain animal leathers. For this purpose, the use of synthetic leather has been proposed as an alternative to the cow, sheep or deer leather currently used. However, products obtained in this way are not always satisfactory or appreciated by consumers.

In this sector, there is a particular need to provide products that have equivalent or similar characteristics or properties to natural leather products, but at the same time have reduced environmental impact.

It was proposed to use leather of natural origin but from animals other than those currently widely used because it is more readily available or has reduced environmental impact. For example, the use of fish leather has been proposed.

However, fish leather must be treated in such a way as to obtain suitable final properties that are comparable, for example, with those of animal leather currently in use. In particular, it is necessary to treat the fish leather to make it wear-resistant, waterproof and water-resistant.

A number of methods have been proposed to give the fish leather water-repellent and hydrophobic properties, however, most of the proposed solutions involve the use of silicones and petroleum-derived materials. Furthermore, the proposed solutions only provide the desired properties of the leather for a limited period of time, as the properties of fish leather tend to deteriorate noticeably over time or with use.

Shida Miao et al. “Preparation and characterization of epoxidized soybean oil-based paper composite as potential water-resistant materials”, Journal of Applied Polymer Science, 2014, describes the production of a poly epoxidized soybean oil (PESO)-coated paper composite with good water-resistant properties by in situ polymerisation of epoxidized soybean oil (ESO) on paper. In detail, ESO is initially mixed with tetrahydrofuran. Diethyl ether-boron trifluoride is then added to the solution. After a mixing operation, a certain amount of the monomer solution is poured onto the paper substrate. Tetrahydrofuran is evaporated for 24 hours in a hood. The hydrophobic covering is formed by an epoxide ring-opening polymerisation of ESO in the presence of diethyl ether-boron trifluoride as a catalyst after evaporation of tetrahydrofuran.

However, toxic reagents are used in the process described therein; in fact, diethyl ether-boron trifluoride is toxic, as is the solvent used, tetrahydrofuran. Moreover, such a process does not provide a suitable covering to impart the desired properties to the substrate in a stable and long-lasting manner.

WO2021/119069A1 describes an elastomeric composite material containing thermoplastic collagen comprising: collagen having at least a first reactive functional group, a thermoplastic elastomer having at least a second reactive functional group; wherein the collagen and elastomer are bonded together by covalent bonding through the reaction of the first and second reactive functional groups. The first reactive functional group is an amine group, a hydroxyl group or a carboxylic acid group. The second reactive functional group in the composite material is a maleic acid anhydride, an epoxide group, a silane or glycidyl group.

WO2021/119069A1 further describes a method for making a collagen-containing elastomeric composite material in which collagen is mixed with a thermoplastic elastomer and at least one softener and the resulting mixture is heated to a temperature comprised between approximately 80° C. and approximately 180° C. The composite material containing collagen and a thermoplastic polymer can be processed to form a film that can eventually be laid on a fabric or other substrate.

Following WO02021/119069A1, a substrate containing collagen covered with a thermoplastic polymer can be obtained. However, even in this case, the covering tends to separate from the substrate. Therefore, a material in which the substrate and the covering are permanently bonded is not produced. In addition, the covering created is not hydrophobic, in fact, to create a hydrophobic covering you must add a lubricant.

In the present description as well as in the accompanying claims, certain terms and expressions are deemed to have the meaning expressed in the following definitions, unless expressly stated otherwise.

The term “substrate” refers to a material with at least a first surface on which a covering can be applied. The substrate is preferably a flexible material of essentially two-dimensional shape with two dimensions considerably larger than the third dimension. The third dimension is referred to as the substrate thickness. The substrate is preferably one of natural origin, either animal or plant, such as leather, fish leather, or a substrate containing cotton.

The term “covering” refers to a layer applied to a surface of a substrate adapted to cover at least partially, preferably completely, a surface of the substrate. The covering can be applied to both opposite surfaces of the substrate, or completely cover the substrate, so that the substrate is surrounded by the covering. The covering may have hydrophobic, water-repellent, waterproof properties.

The term “film” refers to a substantially continuous layer of a material with a limited thickness.

The term “composite material” refers to a material comprising a substrate and a covering film applied to at least a portion of a surface of the substrate, preferably to a surface of the substrate. The composite material may therefore comprise a layer formed by the substrate and at least a second layer applied to the first layer and comprising the covering. The covering is preferably applied directly onto the substrate without the use of adhesives or the like. The covering can be applied to two opposing surfaces of the substrate. In some versions, the covering may surround the surface of the substrate in its entirety.

The term “polyfunctional” refers to a compound having molecules provided with a plurality of functional groups for each molecule. A functional group indicates a part of the structure of a molecule characterised by specific elements and a well-defined and precise structure, which gives the compound a typical reactivity similar to that of other compounds containing the same group.

The Applicant has highlighted that there remains a need to provide a composite material that is waterproof and water-repellent and maintains these properties over time with a substrate of natural origin and a covering applied to the substrate. The Applicant has also noted that it is desirable to provide a composite material whose preparation process has a limited environmental impact, both in terms of the raw materials used and any additional reagents used, as well as the energy requirements.

The Applicant has verified that in order to create a composite material comprising a substrate and a covering that would maintain certain desired properties over time, it was necessary to stably bond the covering to the substrate, preferably by inducing the formation of covalent bonds between the molecules of the covering and those of the substrate.

In particular, the Applicant has verified that in order to make a composite material that would remain waterproof over time, it was necessary to stably bond a waterproof covering to the substrate used.

The Applicant has also verified that it was advantageous to chemically bond the covering to the substrate via bonds made at the respective functional groups.

The Applicant has verified that it was advantageous to produce a covering film having at least a first compound suitable for bonding to functional groups of the substrate and a second compound bonded to the first compound.

The Applicant has verified that in this way it was possible to form a stable film firmly adhering to the substrate. In addition, the Applicant has verified that this arrangement provided a covering that homogeneously protected the substrate.

In a first aspect, therefore, the invention concerns a method for making a composite material comprising at least one substrate and a covering applied to the substrate.

Preferably, the method envisages providing a substrate containing a plurality of functional groups which are selected from a group comprising a carboxyl group (—COOH), amino group (—NH₂), thiol group (—RSH), hydroxyl group (—OH) or a combination thereof.

Preferably, the method comprises mixing approximately from 30 to 70% by weight of a first compound with from 70 to 30% by weight of a second compound until obtaining a first homogeneous solution comprising said first compound and said second compound.

Preferably said first compound is an epoxidized compound comprising at least 1.5 epoxide groups per molecule.

Preferably said second compound is a polyfunctional compound, comprising a plurality of functional groups, preferably bifunctional or trifunctional.

Preferably, the method comprises applying said first solution to said substrate.

Preferably, the method comprises subjecting said substrate to a drying step.

Preferably, said method comprises subjecting said substrate provided with said first solution to a cross-linking step.

Preferably said cross-linking step comprises maintaining said substrate at a temperature comprised between approximately 50° C. and approximately 90° C. for such a cross-linking time as to cause an opening reaction of at least a portion of the epoxide groups of the first compound in order to form a bond between said first compound with said second compound and said substrate in the region of at least some of the functional groups of said second compound and said substrate and a bond between said first compound and said substrate in the region of at least some of the functional groups of said substrate.

In a second aspect thereof the invention concerns a method for making a composite material comprising at least one substrate and a covering applied to the substrate.

Preferably, the method envisages providing a substrate containing a plurality of functional groups which are selected from a group comprising a carboxyl group (—COOH), amino group (—NH₂), thiol group (—RSH), hydroxyl group (—OH) or a combination thereof.

Preferably, the method comprises mixing approximately from 30 to 70% by weight of a first compound with from 70 to 30% by weight of a second compound until obtaining a first homogeneous solution comprising said first compound and said second compound.

Preferably said first compound is an epoxidized compound comprising at least 1.5 epoxide groups per molecule.

Preferably said second compound is a polyfunctional, preferably bifunctional, or trifunctional, compound.

Preferably said method comprises adding from 0.1 to 99% by weight of a solvent to said first solution so as to obtain a second solution comprising said first compound, said second compound and said solvent.

Preferably, the method comprises applying said second solution to said substrate.

Preferably, the method comprises subjecting said substrate to a drying step.

Preferably, said method comprises subjecting said substrate provided with said second solution to a cross-linking step.

Preferably said cross-linking step comprises maintaining said substrate at a temperature comprised between approximately 50° C. and approximately 90° C. for such a cross-linking time as to cause an opening reaction of at least a portion of the epoxide groups of the first compound in order to form a bond between said first compound with said second compound and said substrate in the region of at least some of the functional groups of said second compound and said substrate and a bond between said first compound and said substrate in the region of at least some of the functional groups of said substrate.

In a third aspect of the invention, a composite material comprising a substrate and a covering layer bonded to the substrate is provided.

Preferably, the substrate comprises a plurality of functional groups which are selected from a group comprising a carboxyl group (—COOH), amino group (—NH₂), thiol group (—RSH), hydroxyl group (—OH) or a combination thereof.

Preferably said covering comprises a first compound having at least 1.5 epoxide groups per molecule and a second polyfunctional compound preferably bifunctional or trifunctional, preferably selected from a group comprising bifunctional carboxylic acids, trifunctional carboxylic acids, a plurality of carboxylic acids having at least 2 or 3 carboxyl groups, dimer carboxylic acids, trimer carboxylic acids, polyfunctional amines, diamines, triamines or admixtures thereof.

Preferably, said substrate and said covering material are cross-linked to form bonds between said substrate and said covering material, so that in said composite material said first compound contains at least 1.5 hydroxyl groups per molecule, said first compound is bonded to said second compound and said substrate in the region of at least some of the functional groups of said second compound and said substrate, and said first compound is bonded to said substrate in the region of at least some of the functional groups of said substrate.

Owing to these characteristics a composite material is obtained having a substrate and a covering firmly bonded together through stable, high-energy bonds. This results in a composite material in which the covering homogeneously covers the substrate.

The result is a composite material with a substrate and a covering layer bonded to the substrate adapted to make the substrate waterproof, water-repellent and breathable.

The covering layer is first applied to the substrate and then chemically bonded to the substrate itself.

The covering layer is stably bonded to the substrate.

The bonds formed between the functional groups of the first compound and the functional groups of the substrate allow for stable bonding of the first compound to the substrate. The high-energy covalent bonds formed between at least some of the functional groups and at least some of the functional groups of the covering allow the covering to be stably bonded to the substrate.

The bonds formed between the functional groups of the first compound and the functional groups of the second compound allow the first compound to be stably bonded to the second compound. In this case, the first compound is interposed between the second compound and the substrate and a cross-link is generated between the substrate, first compound and second compound.

During the cross-linking step, an opening reaction of the epoxide ring of the first compound and the formation of a bond of the first compound with the substrate and with the second compound, and in particular between the epoxide group of the first compound and the functional groups of the substrate and/or the second compound, occurs.

These bonds are formed at the functional groups of the substrate and the second compound. These bonds are highly stable bonds.

Some molecules of the first compound are bonded to certain functional groups of the substrate. Some molecules of the first compound are bonded to a functional group of the substrate and to a molecule of the second compound. The latter in turn can be bonded to another molecule of the first compound.

The molecules of the first compound are bonded to the substrate. At least some molecules of the first compound are also bonded to the second compound. In this way, the molecules of the second compound evenly cover the substrate, protecting it and making it uniformly water-repellent and waterproof. Moreover, in this way it is not necessary for all functional groups of the substrate to be affected by the bond of the first and/or second compound in order to obtain a waterproof material.

The second compound, bonded to the first compound, tends to position itself above the substrate, covering the substrate and increasing the covering effect of the substrate. In the event that the first or second compound has waterproof properties, this optimises the waterproofing of the substrate.

At the end of the process, the substrate shows a covering that is applied to the substrate but at the same time is interpenetrated into the structure of the substrate. The covering substantially envelops the fibres of the substrate, without altering the microstructure of the substrate itself.

The result is a composite material that has excellent water resistance, but at the same time has essentially the same breathability and flexibility as the substrate without the covering.

The presence of a covering permanently bonded to the substrate increases its thickness and at the same time decreases its porosity; these characteristics are strongly correlated to the permeability of air through the materials, therefore, a composite material with significant breathability properties is obtained.

By appropriately choosing the first and/or second compound, it is possible to create a hydrophobic, water-repellent and waterproof covering. Water vapour permeability follows a process of adsorption and diffusion; by appropriately choosing the first compound and the second compound, both processes can be inhibited, enhancing the impermeability of the resulting composite material. Moreover, by appropriately regulating the cross-linking step, a composite material with a final porosity structure that inhibits the diffusion of water vapour by capillarity can be obtained.

Moreover, these advantages can be achieved by using raw materials of natural origin.

Moreover, these advantages can be achieved by avoiding the use of reagents with high environmental impact.

Moreover, the energy and environmental impact of the process according to the invention is also limited.

The covering made according to the invention is durable.

The cross-linking step, by means of an epoxide ring-opening reaction, allows the creation of a stable “cross-link” between first compound, second compound and substrate. This cross-link has a structure that inhibits the diffusion of water molecules towards the substrate.

The homogeneity of the bonds between the molecules of the covering and the substrate also increases the homogeneity of the properties of the composite material obtained.

Thus, the covering film is not only applied onto the substrate but also permanently bonded by chemical bonds to the substrate itself. This increases the stability over time of the properties of the composite material obtained.

The molecules of the first compound and the second compound penetrate into the structure of the substrate, therefore, the covering action and in particular the waterproofing and water-repellent properties are not limited to a surface layer of the substrate but are also developed in the thickness of the substrate.

The invention makes it possible to produce a covering that not only protects the substrate from water, but also does not lose this property even after prolonged contact with water, preserving the stability of the composite material obtained by applying the covering to the substrate.

The present invention, in at least one of the aforementioned aspects, may have at least one of the further preferred features listed below.

In some versions of the invention, the cross-linking reaction may involve only some of the functional groups of the substrate, and/or the first compound and/or the second compound.

In some versions of the invention, the cross-linking reaction may involve only some of the functional groups of the substrate, and substantially all of the functional groups of the first compound and/or the second compound.

Preferably said cross-linking step allows bonding of at least 80%, preferably at least 90% of the functional groups of the substrate to said first compound and/or to said first compound and said second compound.

Preferably, said cross-linking step allows a bond to be created substantially in the region of all the functional groups of the substrate.

Preferably said drying step comprises placing said substrate provided with said first solution in a fume hood for an interval of at least approximately 30 minutes to dry said substrate. Preferably, said cross-linking step comprises placing the substrate provided with the first solution in a cross-linking oven and maintaining said substrate in said cross-linking oven at a temperature comprised between approximately 50° C. and approximately 90° C. for a desired cross-linking time. The cross-linking time is chosen so as to cause an opening reaction of at least part of the epoxide groups of the first compound to form a bond of said first compound with said second compound and with said substrate in the region of at least at some of the functional groups of said second compound and of said substrate and a bond between said first compound and said substrate in the region of at least at some of the functional groups of said substrate.

Preferably, said cross-linking step allows a bond to be created substantially in the region of all the functional groups of the substrate.

Preferably, said cross-linking step allows a bond to be created substantially in the region of all the functional groups of the substrate and of the first compound.

Preferably said cross-linking step allows at least 80%, preferably at least 90%, of the functional groups of the substrate to be bonded to said first compound.

Preferably in said composite material substantially all the functional groups of the substrate are bonded to said first compound.

Preferably in said composite material at least 80%, preferably at least 90%, of the functional groups of the substrate are bonded to said first compound.

Preferably said second compound is bonded to one of the two carbon atoms of the epoxide group. In other words, upon cross-linking the epoxide group of the first compound opens, one carbon atom of the epoxide group remains bonded to a hydroxyl group (—OH) and the other carbon atom bonds to the second compound.

Preferably said substrate is bonded to one of the two carbon atoms of the epoxide group.

In other words, upon cross-linking the epoxide group opens, one carbon atom of the epoxide group remains bonded to a hydroxyl group (—OH) and the other carbon atom to the functional group of the substrate.

Preferably said plurality of functional groups of said substrate comprises carboxyl groups (—COOH) and/or amine groups (—NH₂) or both.

Two possible reactions between the first compound and the functional groups of the substrate during the cross-linking step are shown below:

Reaction of the amine group of the substrate with the epoxide group of the first compound (two possible structures)

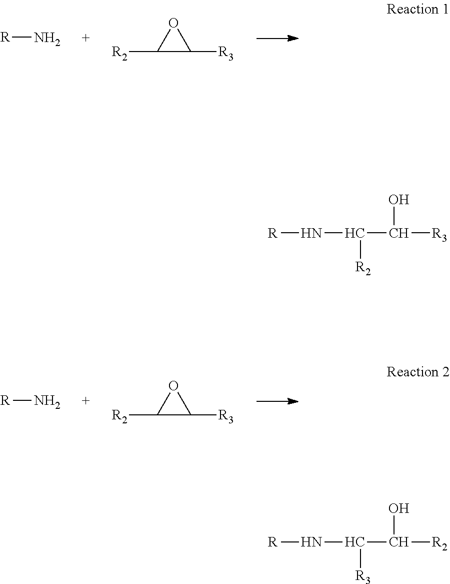

Reaction of the carboxyl group of the substrate with the epoxide group of the first compound (two possible structures)

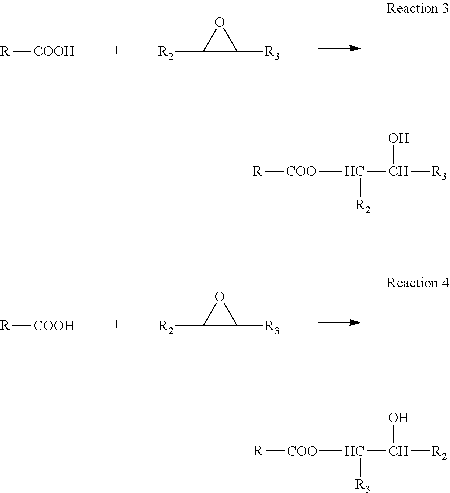

Where R indicates the chain of the substrate molecule whose formula depends on the type of substrate used; R2, R3 indicate the radicals of the first compound molecule and the formula depends on the type of epoxide compound used and the position of the epoxide group in the molecule.

Preferably, the substrate comprises at least one protein.

Preferably the substrate comprises collagen with a plurality of carboxyl groups (—COOH) and a plurality of amine groups (—NH₂).

Preferably the substrate of the invention comprises a leather of natural origin, preferably fish leather, even more preferably salmon leather.

Fish leather, and in particular salmon leather, are by-products of aquaculture processes and often remain unused or used as feed in aquaculture. This causes environmental problems due to the increase in pollution associated with aquaculture facilities.

With the method of the invention, it is possible to treat fish leather, and in particular salmon leather, transforming it into a material that can be advantageously and effectively used in many industrial fields. Waste is thus turned into a resource without having to resort to processes with high environmental impact.

Preferably the substrate of the invention comprises plant fibres, preferably it is comprised of plant fibres, preferably cotton fibres. In some preferred versions, the substrate is woolen fabric or cotton fabric.

Preferably, the method comprises mixing approximately 40-0% by weight of said first compound with approximately 60-40% by weight of said second compound until said first homogeneous solution of said first compound and said second compound is obtained.

Preferably, the method comprises mixing approximately 43-57% by weight of said first compound with approximately 57-43% by weight of said second compound until said first homogeneous solution of said first compound and said second compound is obtained.

Preferably, the method comprises mixing approximately 56% by weight of said first compound with approximately 44% by weight of said second compound until a homogeneous solution of said first compound and said second compound is obtained.

Preferably said first compound is an epoxidized compound comprising at least 2 epoxide groups per molecule.

Preferably said first compound is an epoxidized compound comprising at least 3 epoxide groups per molecule.

Preferably said first compound is an epoxidized compound comprising at least 4 epoxide groups per molecule.

Preferably said first compound is an epoxidized compound comprising at least 6 epoxide groups per molecule.

Preferably said first compound is chosen from a group comprising triglycerides, saturated triglycerides, non-saturated triglycerides, polyunsaturated triglycerides, transesterified oils, transesterified oils having two molecules of fatty acids, transesterified oils having a molecule of fatty acid, or non-esterified oils, or the admixtures thereof, and having at least 1.5 epoxide groups per molecule, preferably at least 3 epoxide groups per molecule.

Preferably, the first compound is a compound with an amphiphilic molecule, i.e. one that possesses both polar groups capable of reacting with the functional groups of the substrate and the second compound as well as long hydrophobic alkyl chains that enhance the water-repellent properties of the final composite material. In addition, during cross-linking, long alkyl chains favour the formation of a final structure with low porosity, which inhibits the diffusion of water molecules towards the substrate but at the same time allows air molecules to pass through.

Preferably said first compound is an epoxidized vegetable oil.

Preferably, the vegetable oil is selected from a group comprising argan oil, peanut oil, avocado oil, safflower oil, coconut oil, rapeseed oil, jatropha oil, behen oil, jojoba oil, lentisk oil, linseed oil, macadamia oil, almond oil, hazelnut oil, walnut oil, olive oil, palm oil, bifurcated palm oil, palm kernel oil, pistachio oil, castor oil, rice oil, wild rose oil, sapote oil, peanut seed oil, borage seed oil, hemp seed oil, cotton seed oil, sunflower seed oil, maize seed oil, sesame seed oil, soy bean oil, tobacco seed oil, pumpkin seed oil, grape seed oil.

Preferably, said first compound is an epoxidized vegetable oil in which the vegetable oil consists of fatty acids selected from a group including: palmitic acid, stearic acid, oleic acid, linoleic acid, linolenic acid, lauric acid, palmitoleic acid, and ricinoleic acid.

Preferably said first compound is an epoxidized soybean oil.

Preferably said first compound is an epoxidized soybean oil (ESO) having approximately three epoxide groups per molecule.

By using an epoxidized vegetable oil, raw materials of natural origin, in particular of plant origin, can be used. This avoids the use of petroleum-derived compounds.

In particular, epoxidized soybean oil (ESO) is readily available and inexpensive.

In addition, soybean oil naturally has double bonds that favour the inclusion of functional groups and the reactivity of soybean oil itself.

In addition, epoxidized soybean oil (ESO) is suitable for imparting hydrophobic properties to a substrate to which it is applied.

In addition, epoxidized oils are naturally reactive, allowing them to create stable bonds with the compounds they react with.

Preferably said second compound comprises one or more polyfunctional compounds selected from a group comprising carboxylic acid having at least 2 or 3 carboxylic groups, a plurality of carboxylic acids having at least 2 or 3 carboxylic groups, a polyamine having at least 2 or 3 amino groups, a plurality of polyamines having at least 2 or 3 amino groups, or admixtures thereof.

Preferably, said second compound comprises one or more compounds selected from a group comprising bifunctional carboxylic acids, trifunctional carboxylic acids, dimer carboxylic acids, trimer carboxylic acids, polyfunctional amines, diamines, triamines or admixtures thereof.

In some versions, said second compound comprises one or more cyclic anhydrides of one or more compounds selected from a group comprising bifunctional carboxylic acids, trifunctional carboxylic acids, dimer carboxylic acids, trimer carboxylic acids or admixtures thereof.

Two possible reactions between the first compound with the epoxide ring and the second compound with at least one carboxylic functional group (—COOH) occurring during the cross-linking step are shown below:

Reaction of the carboxylic group of the second compound with the epoxide group (two possible structures)

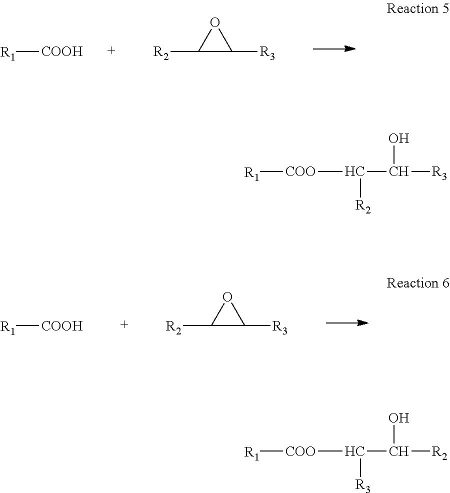

Where R1 indicates the chain of the molecule of the second compound whose formula depends on the type of second compound used, the position of the carboxyl group involved in the reaction and the number of carboxyl groups in the molecule; R2, R3 indicate the radicals in the molecule of the first compound and the formula depends on the type of epoxide compound used and the position of the epoxide group in the molecule.

Preferably said second compound comprises a dimer acid and/or a trimer acid of unsaturated fatty acids, or an admixture thereof.

Preferably said second compound is selected from a group comprising: unsaturated fatty acids, preferably oleic acid, linoleic acid, partially hydrogenated fatty acids, or admixtures thereof.

Preferably said second compound is a mixture of trimer tricarboxylic acids and dimer dicarboxylic acids.

Preferably said second compound is a mixture comprising approximately 60-90% by weight of trimer tricarboxylic acids and approximately 40-10% by weight of dimer dicarboxylic acids, preferably approximately 70-85% by weight of trimer tricarboxylicacids and approximately 30-15% by weight of dimer dicarboxylic acids.

Preferably, said second compound is a mixture comprising approximately 77% by weight of trimer tricarboxylic acids and approximately 23% by weight of dimer dicarboxylic acids.

Preferably said second compound is known as Pripol™ 1040 supplied by CRODA.

In a preferred version, said first solution comprises approximately 55% of epoxidized soybean oil (ESO) and approximately 45% of a trimer acid, preferably PRIPOL™ 1040.

This provides a covering based on epoxidized soybean oil and trimer acid that is suitable for application to a substrate and imparts hydrophobic properties to the substrate. This provides a covering based on epoxidized soybean oil and trimer acid that is suitable for stable application to a substrate containing functional groups such as carboxylic group (—COOH), amine group (—NH₂), thiol group (—RSH), hydroxyl group (—OH), e.g. a protein-containing substrate and in particular a collagen-containing substrate. This covering is suitable for achieving a strong bond between the covering and the substrate.

Below are reported some possible bonds that occur as a result of the reactions of the cross-linking step using a collagen-containing substrate, an epoxidized soybean oil as the first compound and a mono- or poly-functional carboxylic acid as the second compound.

Two possible formulae of bonds between the substrate and the first compound:

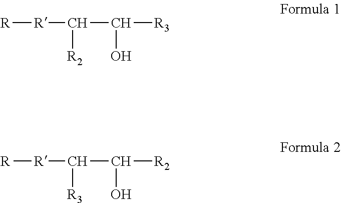

Two possible formulae of bonds between the first compound of the substrate and the second compound:

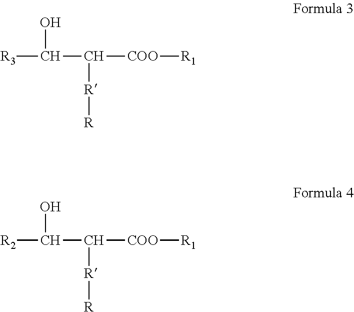

Four possible formulae of bonds between the first compound of the substrate and the second compound:

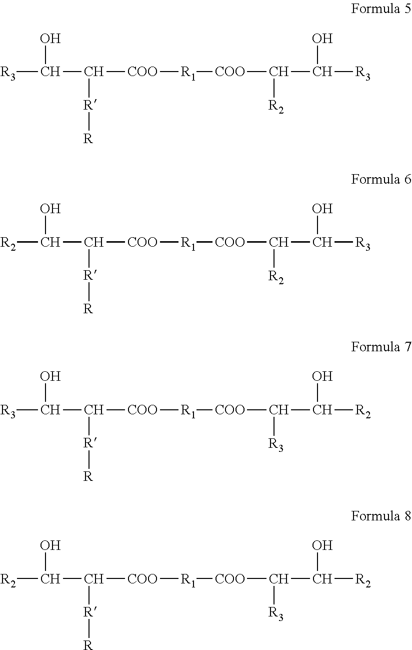

where R₂ and R₃ indicate radicals of the molecule of the first compound and the formula depends on the type of epoxide compound used and the position of the epoxide group in the molecule, R₁ indicates a radical of the molecule of the second compound and the formula depends on the type of second compound used and the position of the carboxyl group involved in the reaction, R′ indicates a functional group of the collagen (—NH₂ o —COOH), R indicates the chain of the molecule of the substrate whose formula depends on the type of substrate used.

The first compound and the second compound are thus firmly attached to the substrate at its functional groups. A cross-link is created between the first compound, the second compound and the substrate, allowing the substrate to be evenly coated and protected.

During the cross-linking step, an opening of the epoxide ring of the epoxidized soybean oil takes place, which enables the creation of a cross-link between the epoxidized soybean oil, the trimer and/or dimer acid and the substrate.

By using a first solution comprising epoxidized soybean oil and dimer acid and/or a trimer acid, a covering is created that is stably bonded to a collagen-containing substrate, and which during the cross-linking step bonds them to the substrate, generating a cross-link between the epoxidized soybean oil, the trimer acid and the functional groups of the collagen of the substrate.

In other words, by opening the epoxide rings of the epoxidized soybean oil, the latter can bond to a functional group of the collagen, and the second compound bonds the collagen of the substrate and the second compound together. The bonds formed are particularly stable and the covering is firmly bonded to the substrate.

The solution of the invention allows, as mentioned above, by means of an epoxide ring opening reaction of the epoxidized soybean oil, the creation of a “cross-link” between the epoxidized soybean oil, the trimer and/or dimer acid and the functional groups of the substrate.

In addition, the trimer and/or dimer acid and epoxidized soybean oil have a high affinity for the collagen molecules of the substrate, so they tend to penetrate the substrate structure by being partially adsorbed by the substrate itself.

The cross-linking step, by means of an epoxide ring-opening reaction, allows the creation of a stable “cross-link” between the ESO, the trimer and/or dimer acid and the collagen.

The epoxidized soybean oil is also suitable for bonding to collagen at both a carboxyl and amine functional group. This increases the reactivity of the first solution. In addition, collagen also includes the amino acids methionine and cysteine with which epoxidized soy bean oil is able to form disulphide bridges, i.e. very stable bonds with high bonding energy.

This also increases the coverage of the substrate by the covering and in particular the first compound. In addition, a covering is created that is very homogeneously bonded to the substrate.

The trimer and/or dimer acid bonded to the soybean oil stabilises the bond of the soybean oil with the collagen on the one hand and increases the hydrophobic properties of the covering obtained on the other. This results in a highly waterproof and water-repellent composite material.

Moreover, the bonds formed during the cross-linking step are highly stable, so these properties are maintained over time.

Dynamic contact angle measurements revealed excellent water resistance of the substrate covered with a covering comprising epoxidized soybean oil and trimer and/or dimer acid, without changing the characteristics of the substrate such as breathability and flexibility.

Preferably said applying comprises spraying said first solution onto said substrate.

Preferably said applying comprises soaking said substrate in said first solution.

Preferably said applying comprises soaking said substrate in said first solution for a period of time sufficient to wet said substrate with said first solution, preferably for a period of time comprised between approximately 5 and approximately 60 seconds.

This results in homogeneous wetting of the substrate with the first solution.

Preferably said drying step is conducted over a period of at least 40 minutes, preferably approximately 1 hour to dry said substrate. In other versions, the drying step can be conducted for a longer time.

Preferably, said temperature of said cross-linking step is comprised between approximately 75° and approximately 80° C.

Such temperature ranges also allow delicate substrates, which would deteriorate at higher temperatures, to be used in the invention, while at the same time enabling a stable bond between the substrate and the first compound and the second compound.

Preferably the drying step is at a temperature comprised between approximately 15° C. and approximately 40° C., preferably between approximately 20° C. and approximately 35° C., preferably between approximately 25° C. and approximately 30° C.

Preferably said drying step is carried out at room temperature.

Preferably the cross-linking step is provided after the drying step.

Preferably said cross-linking time is comprised between 5 and 20 days, preferably around 14 days.

This results in a cross-linking reaction involving more than 90% of the functional groups of the substrate, the first compound and the second compound.

Preferably, the cross-linking step takes place at ambient pressure.

Preferably, said first solution consists only of the first compound and the second compound.

Preferably said method comprises adding from 0.1 to 99% by weight of a solvent to said first solution so as to obtain a second solution comprising said first compound, said second compound and said solvent.

This results in a second solution comprising the first compound, the second compound and a solvent.

The addition of the solvent allows the viscosity of the solution to be adjusted, resulting in a second solution with a desired viscosity. The viscosity of the second solution can be adjusted by varying the amount and type of solvent used.

The viscosity of the first solution can be adjusted by varying the first and/or second compound used to form the first solution.

By varying the viscosity of the second solution and/or the first solution, the interaction of the second solution and/or the first solution with the substrate can be favoured.

In this case, at least partial evaporation of the solvent occurs during the drying step.

In this case, at least partial evaporation of the solvent occurs during the cross-linking step.

Preferably, said drying step is conducted in such a way as to cause the solvent to evaporate almost completely.

Preferably said drying step is conducted in such a way as to cause the evaporation of at least 50% of the solvent, preferably at least 75%, more preferably at least 95% of the solvent.

Preferably, said cross-linking step is conducted in such a way as to cause the solvent to evaporate almost completely.

Preferably, said cross-linking step is conducted in such away as to cause the evaporation of at least 50% of the solvent, preferably at least 75%, more preferably at least 95% of the solvent.

Preferably, the method involves adding enough solvent to obtain a second solution with a viscosity such as to enable said second solution to be applied to the substrate. The amount of solvent, and thus the viscosity of the solution, is selected according to the technique used in the application step to apply the second solution to the substrate. The presence of the solvent allows the covering to be evenly applied by airbrushing and spraying.

Preferably said second solution contains between approximately 1% w/w and approximately 20% w/w of said solvent.

Preferably said second solution contains approximately 1% w/w of said solvent.

Preferably said second solution contains approximately 5% w/w of said solvent.

Preferably said second solution contains approximately 10% w/w of said solvent.

Preferably said second solution contains approximately 15% w/w of said solvent.

Preferably said second solution comprises said first solution and said solvent in a ratio (first compound+second compound):solvent=0.2:1.

Preferably said solvent is selected from a group comprising ethyl acetate, 2-propanol, ethanol.

Preferably said solvent is selected to be similar to said first compound and/or said second compound so as to obtain a second homogeneous solution of said first compound, said second compound and said solvent.

Preferably, said drying step is provided after said application step.

Preferably said applying said first solution and/or said second solution on said substrate comprises immersing said substrate in said first solution and/or said second solution, dip coating.

Preferably said applying said first solution and/or said second solution on said substrate comprises covering said substrate by rotation with said first solution and/or said second solution, spin coating.

Preferably said applying said first solution and/or said second solution on said substrate comprises immersing said substrate in said first solution and/or said second solution for covering said substrate by dip coating.

Preferably said applying said first solution and/or said second solution on said substrate comprises spraying said first solution and/or said second solution on said substrate, spray coating.

Preferably, said cross-linking step is provided after said drying step.

Preferably said composite material comprises said substrate and said covering.

Preferably said composite material consists of said substrate and said covering.

Preferably the composite material of the invention is waterproof and water-repellent.

Preferably, the method comprises subjecting said composite material to finishing operations. Finishing operations can be selected from the finishing operations used in the treatment of natural leathers, such as tannin fixing, dyeing, greasing.

The finishing operations are preferably carried out after said cross-linking step.

The method of the invention is an ecologically sustainable method, as sustainable and non-polluting raw materials are used, in particular both the first compound and the solvent can be of natural origin and non-polluting.

The cross-linking step is conducted at low temperatures, which decreases the energy expenditure of the method of the invention while allowing for a stable bond between the covering and the substrate.

Furthermore, in the method of the invention there is little, if any, material waste because virtually all of the first compound and the second compound of the first and/or second solution are bonded to the substrate. This highlights the high efficiency of the method of the invention.

This also further limits the environmental impact of the method of the invention as material waste is reduced or limited.

The epoxidized soybean oil gives the substrate excellent water resistance properties while avoiding the use of environmentally unsustainable materials.

Moreover, the method of the invention is reproducible and quite fast.

With the method of the invention, the cross-linking step can be conducted at a temperature that prevents thermal degradation of the collagen-containing substrate, however, said cross-linking step is in any case effective in achieving a stable bond between the covering and the substrate. Furthermore, said cross-linking step can be conducted at ambient pressure.

A composite material comprising an animal leather substrate with modified wettability properties with respect to the initial properties is obtained. Applying the covering of the invention changes the wettability properties of the animal leather, considerably improving the impermeability of the substrate while maintaining breathability and flexibility.

The covering made by the method of the invention is suitable for effective application to various substrates provided they have functional groups suitable for bonding to the first compound.

For example, the covering made by the method of the invention is suitable for effective application to a cotton substrate.

It should be noted that some steps of the methods described above may be independent of the order of execution reported. In addition, some steps may be optional. In addition, some steps of the methods may be performed repetitively, or they may be performed in series or in parallel with other steps of the method.

The characteristics and advantages of the invention will become clearer from the detailed description of an embodiment illustrated, by way of non limiting example, with reference to the appended drawings wherein:

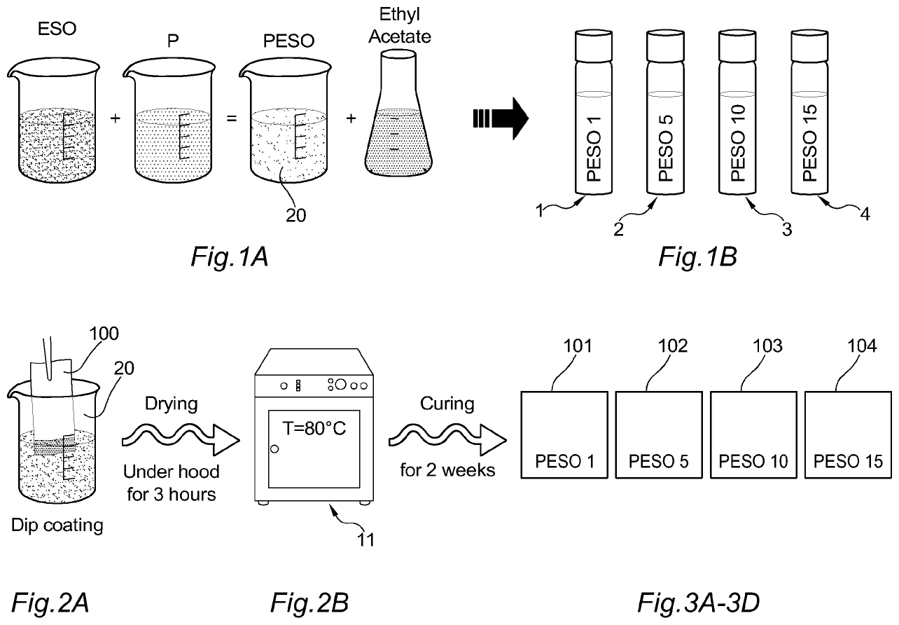

FIG. 1A is a schematic view of the preparation of a first solution and a second solution according to the invention;

FIG. 1B is a schematic view of containers containing a second solution obtained by adding different concentrations of solvent to the first solution: PESO1 (1% w/w solvent), PESO5 (5% w/w solvent); PESO10 (10% w/w solvent); PESO15 (15% w/w solvent).

FIGS. 2A and 2B are schematic views of two distinct steps of the method of the invention;

FIG. 3 is a schematic view of 4 substrates obtained by the method of the invention, respectively, with solutions PESO1 (FIG. 3A), PESO5 (FIG. 3B); PESO10 (FIG. 3C); PESO15 (FIG. 3D);

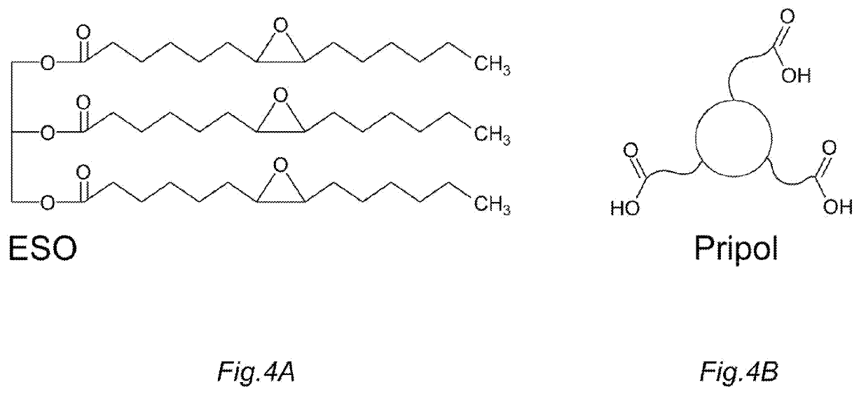

FIGS. 4A-4B represent schematic formulae of a first compound (FIG. 4A), of a second compound (FIG. 4B) to be used in the method of the invention.

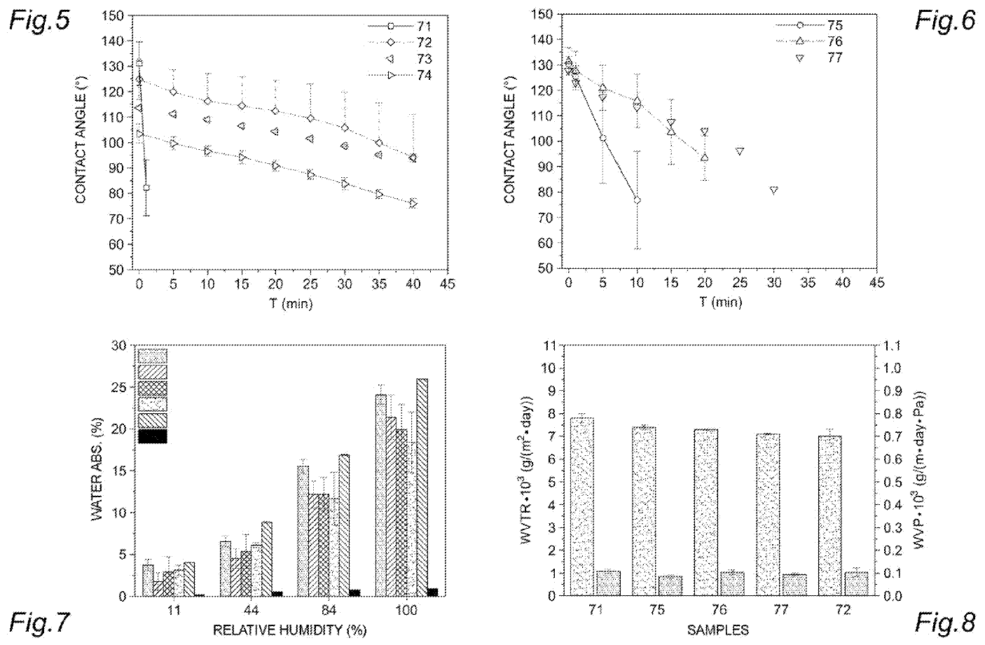

FIG. 5 is a graph representing the development of the contact angle over time for an untreated substrate, a substrate treated according to the invention with the PESO15 solution, a control material (Teflon) and a film made with the first solution PESO;

FIG. 6 is a graph representing the development of the contact angle over time for a substrate treated in accordance with the invention with three different second solutions: solution PESO1, solution PESO5 and solution PESO10;

FIG. 7 is a graph representing water absorption as a function of relative humidity by composite materials according to the invention made with a solution PESO1, PESO5, PESO10, PESO15 of a film made with the first solution PESO;

FIG. 8 is a graph representing the breathability (Water Vapour Transmission Rate, WVTR) and vapour permeability (Water Vapour Permeability) of composite materials according to the invention made with a solution PESO1, PESO5, PESO10, PESO15, of a substrate not treated according to the method of the invention, of a film made with the first solution PESO;

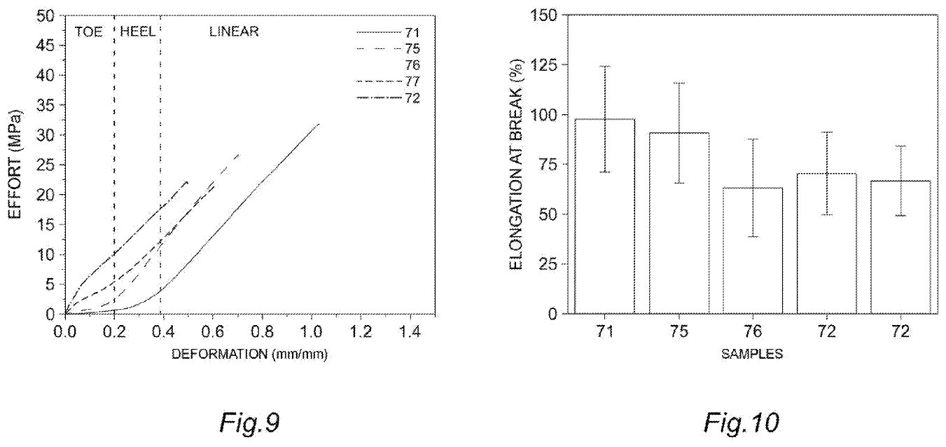

FIG. 9 is a graph depicting the tensile stress as a function of the elongation of composite materials according to the invention made with a solution PESO1, PESO5, PESO10, PESO15, of a substrate not treated by the method of the invention, of a film made with the first solution PESO;

FIG. 10 is a graph depicting the elongation at break of composite materials according to the invention made with a solution PESO1, PESO5, PESO10, PESO15 of a substrate not treated by the method of the invention of a film made with the first solution PESO.

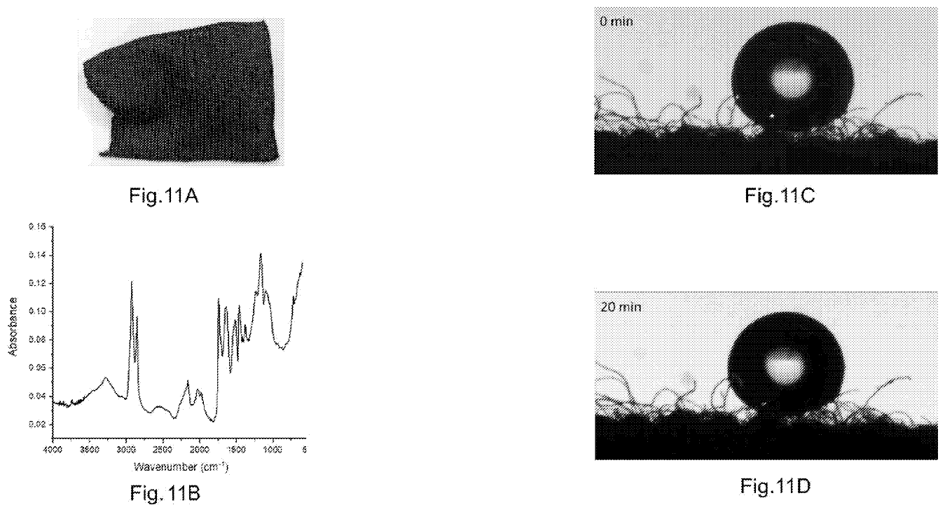

FIG. 11A is a photo of a sample of woolen fabric covered with a covering made from epoxidized soybean oil (ESO) and Pripol 1040 trimer acid;

FIG. 11B shows an FTIR spectrum of the fabric in FIG. 11A;

FIGS. 11C and 11D are contact angle measurements taken at time TO (FIG. 11C) and after 20 minutes (FIG. 11D) for the fabric in FIG. 11A, respectively.

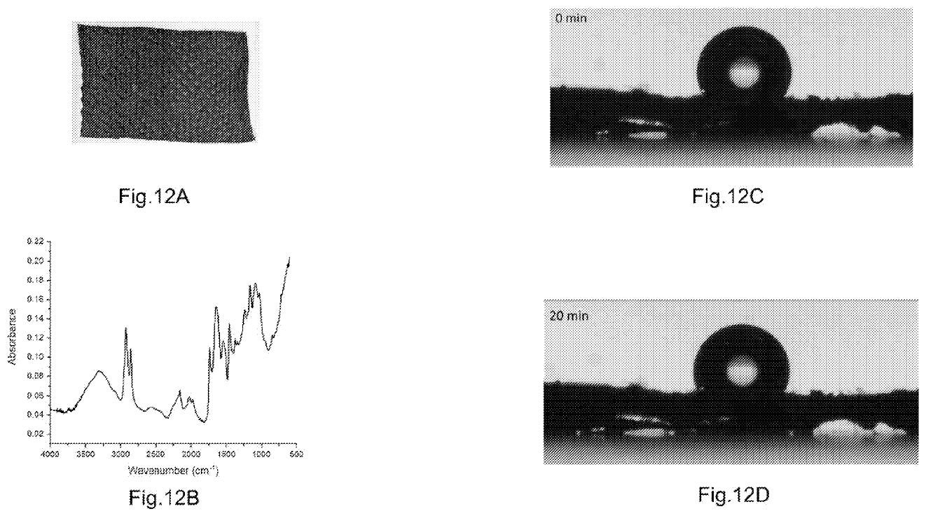

FIG. 12A is a photo of a leather sample covered with a covering obtained from epoxidized soybean oil (ESO) and Pripol 1040 trimer acid;

FIG. 12B shows an FTIR spectrum of the sample in FIG. 12A;

FIGS. 12C and 12D are contact angle measurements taken at time TO (FIG. 12C) and after 20 minutes (FIG. 12D) for the sample in FIG. 12A, respectively.

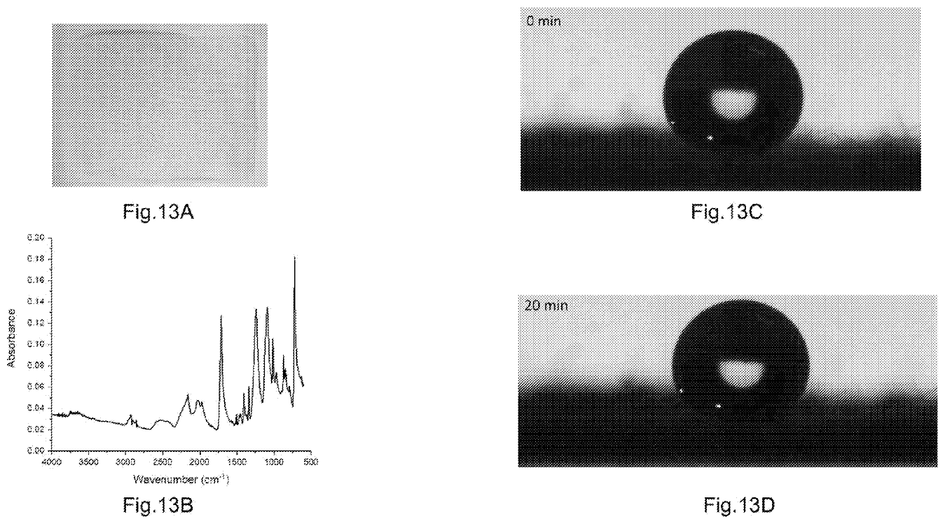

FIG. 13A is a photo of a cotton sample covered with a covering comprising epoxidized soybean oil (ESO) and Pripol 1040 trimer acid;

FIG. 13B shows an FTIR spectrum of the sample in FIG. 13A;

FIGS. 13C and 13D are contact angle measurements taken at time TO (FIG. 13C) and after 20 minutes (FIG. 13D) of the sample in FIG. 13A, respectively.

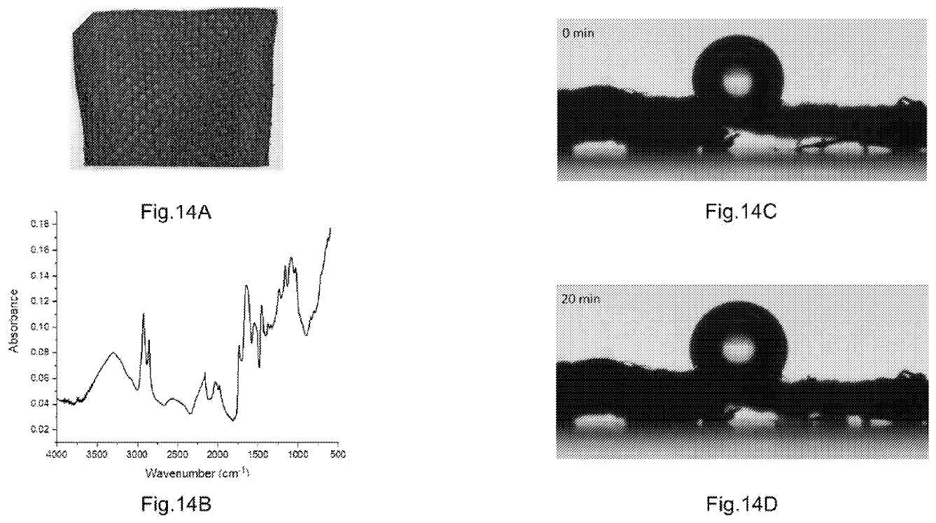

FIG. 14A is a photo of a sample of fish leather with a covering obtained from epoxidized soybean oil (ESO) and Pripol 1040 trimer acid;

FIG. 14B shows an FTIR spectrum of the sample in FIG. 14A;

FIGS. 14C and 14D are contact angle measurements taken at time TO (FIG. 14C) and after 20 minutes (FIG. 14D) of the sample in FIG. 14A, respectively.

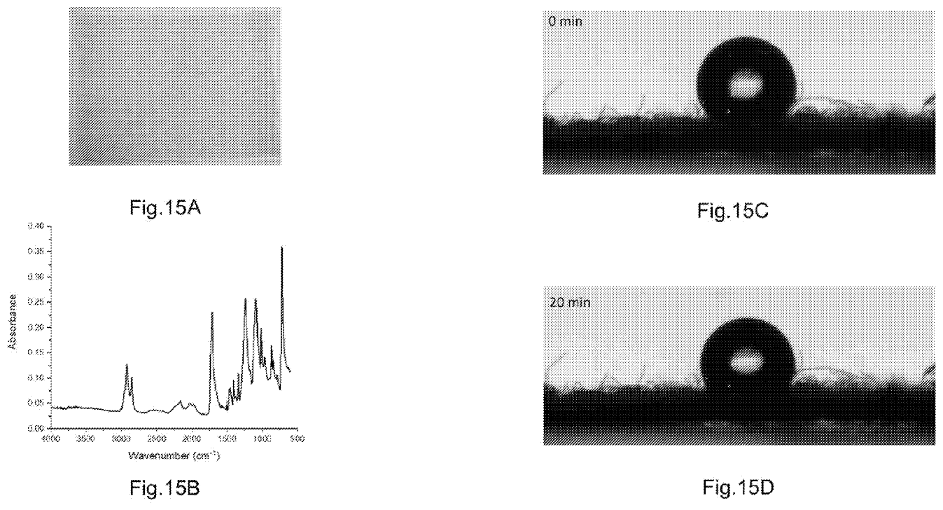

FIG. 15A is a photo of a sample of cotton covered with a covering obtained from epoxidized soya oil (ESO) and Priamine 1071 trimer amine;

FIG. 15B shows an FTIR spectrum of the sample in FIG. 15A;

FIGS. 15C and 13D are contact angle measurements taken at time TO (FIG. 15C) and after 20 minutes (FIG. 13D) of the sample in FIG. 15A, respectively.

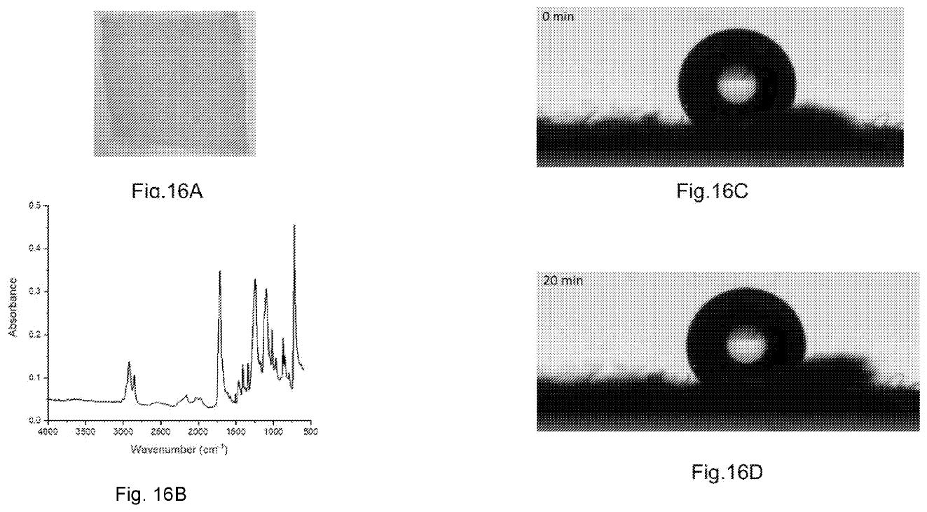

FIG. 16A is a photo of a sample of cotton covered with a covering obtained from epoxidized fatty acids esterified with 1,4-butanediol and Pripol 1040 trimer acid;

FIG. 16B shows an FTIR spectrum of the sample in FIG. 16A;

FIGS. 16C and 16D are contact angle measurements taken at time 0 (FIG. 16C) and after 20 minutes (FIG. 16D) of the sample in FIG. 16A, respectively.

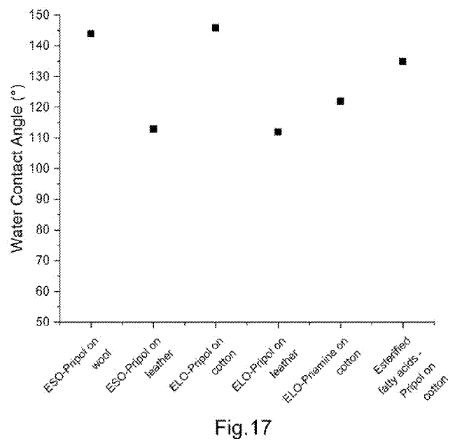

FIG. 17 is a graph showing the contact angle in water for certain materials according to the invention.

The invention will now be described with reference to particular embodiments. In the following, the following terms and abbreviations will be used with the meanings indicated below:
ESO=epoxidized soybean oil;
PESO=first solution according to the invention containing ESO and Pripol 1040;
PESO1=second solution according to the invention obtained by dissolving a desired amount of
PESO in 1% (w/w) ethyl acetate;
PESO5=second solution according to the invention obtained by dissolving a desired amount of
PESO in 5% (w/w) ethyl acetate;
PESO1=second solution according to the invention obtained by dissolving a desired amount of
PESO in 10% (w/w) ethyl acetate;
PESO1=second solution according to the invention obtained by dissolving a desired amount of
PESO in 15% (w/w) ethyl acetate;

### COMPARATIVE EXAMPLE

55.7 g of a trimer acid solution (trade name: Pripol 1040) (P) were mixed with 44.3 g of epoxidized soybean oil (ESO) until completely homogenised, resulting in a first solution 20 indicated as PESO, as shown in FIG. 1A.

An epoxidized soybean oil with approximately three epoxide groups per molecule is used.

The first solution (PESO) was poured into a container and left to dry for 40-60 minutes in a hood.

This solution was then cross-linked in a cross-linking oven. For this purpose, the container was placed in an oven and kept at a temperature of approximately 80° C. for a period of approximately 2 weeks.

A sample of PESO film was then obtained, referred to below as the first sample or PESO (film).

### Example 1

A solution (PESO) was prepared according to the COMPARATIVE EXAMPLE, then this solution (PESO) was dissolved in 1% (w/w) ethyl acetate in order to obtain a second solution 1 referred to as PESO1, as shown in FIG. 1B.

The PESO1 solution was poured into a container 10 and a sample 100 of salmon leather was immersed in the PESO1 solution 1, as shown in FIG. 2A, and kept immersed in the PESO1 solution for a time interval of approximately 30 seconds

Subsequently, the salmon leather sample was removed from the container and subjected to a drying step until the ethyl acetate had completely evaporated, FIG. 2A.

For this purpose, the salmon leather sample provided with the PESO1 solution was placed under a fume hood for approximately three hours at room temperature, approximately 22° C. After the drying step, a salmon leather sample coated with PESO1 solution was obtained.

This resulted in a composite material with a salmon leather substrate onto which a PESO1 solution film is applied.

Subsequently, the salmon leather sample provided with the covering film formed by the PESO1 solution was subjected to a cross-linking step, as shown in FIG. 2B. For this purpose, the salmon leather sample was placed in an oven and kept at a temperature of approximately 80° C. for a period of approximately 2 weeks.

At the end of the cross-linking step, a second sample of composite material 101 is obtained, shown schematically in FIG. 2C and indicated as PESO5.

### Example 2

A solution (PESO) was prepared according to the COMPARATIVE EXAMPLE, then this solution (PESO) was dissolved in 5% (w/w) ethyl acetate to obtain a second solution referred to as PESO5, as shown in FIG. 1B.

The salmon leather sample was treated as explained in EXAMPLE 1.

At the end of the cross-linking step, a third sample of composite material 102 is obtained, shown schematically in FIG. 2C and indicated as PESO5.

### Example 3

A solution (PESO) was prepared according to the COMPARATIVE EXAMPLE, then this solution (PESO) was dissolved in 10% (w/w) ethyl acetate to obtain a second solution referred to as PESO10, as shown in FIG. 1B.

The salmon leather sample was treated as explained in EXAMPLE 1.

At the end of the cross-linking step, a fourth sample of composite material 103 is obtained, shown schematically in FIG. 2C and indicated as PESO10.

### Example 4

A solution (PESO) was prepared according to the COMPARATIVE EXAMPLE, then this solution (PESO) was dissolved in 15% (w/w) ethyl acetate to obtain a second solution indicated as PESO15, as shown in FIG. 1B.

The salmon leather sample was treated as explained in EXAMPLE 1.

At the end of the cross-linking step, a fifth sample of composite material 104 is obtained, shown schematically in FIG. 2C and referred to as PESO15.

### Example 5

A mixture is prepared by mixing 22.2 g of epoxidized soybean oil (ESO) and 27.9 g of trimer acid (trade name: Pripol 1040), the compounds are mixed until completely homogenised. The first solution obtained was diluted in ethyl acetate to form a second solution with a 15% (w/w) concentration of ESO in ethyl acetate.

This second solution was poured into a container and a sample of woolen fabric was immersed in the second solution and kept immersed in the solution for an interval of approximately 60 seconds.

The woolen fabric sample was removed from the container and subjected to drying under a fume hood until the solvent (ethyl acetate) had completely evaporated. For this purpose, the sample of woolen fabric provided with the second solution was placed under a fume hood for a sufficient time to obtain evaporation of the solvent. After the drying step, a sample of covered woolen fabric was obtained.

This resulted in a composite material with a woolen fabric substrate onto which a film of the first solution is applied. Subsequently, the covered substrate was subjected to a cross-linking step.

For this purpose, the woolen fabric sample was placed in an oven and kept at a temperature of approximately 80° C. for a period of approximately 2 weeks.

The woolen fabric sample obtained is shown in FIG. 11A.

This sample was subjected to FTIR analysis, the spectrum of which is shown in FIG. 11B. This spectrum shows the presence of the functional groups of both the cotton substrate and the compounds forming the covering.

The sample obtained was also subjected to a hydrophobicity test by measuring the water contact angle of the sample at an initial time TO (FIG. 11C) and after 20 minutes (FIG. 11D). The drop of water maintains an almost spherical shape, i.e. it does not tend to settle and thus penetrate the material of the sample; therefore, the test shows that the sample of woolen fabric obtained through this example is hydrophobic, contact angle >90°, and that this property is maintained over time.

### Example 6

A mixture is prepared by mixing 22.2 g of epoxidized soybean oil (ESO) and 27.9 g of trimer acid (trade name: Pripol 1040), the compounds are mixed until completely homogenised. The first solution obtained was diluted in ethyl acetate to form a second solution with a 15% (w/w) concentration of ESO in ethyl acetate.

This second solution was poured into a container and a sample of leather was immersed in the second solution and kept immersed in the solution for an interval of approximately 60 seconds.

The leather sample was removed from the container and subjected to a drying step under a fume hood until the solvent (ethyl acetate) had completely evaporated. For this purpose, the sample of leather provided with the second solution was placed under a fume hood for a sufficient time to obtain evaporation of the solvent. After the drying step, a sample of covered leather was obtained. This resulted in a composite material with a leather substrate onto which a film of the first solution is applied. Subsequently, the leather substrate provided with the covering was subjected to a cross-linking step. For this purpose, the leather sample was placed in an oven and kept at a temperature of approximately 80° C. for a period of approximately 2 weeks.

The leather sample obtained is shown in FIG. 12A.

This sample was subjected to FTIR analysis, the spectrum of which is shown in FIG. 12B. This spectrum shows the presence of the functional groups of both the leather substrate and the compounds forming the covering.

The sample obtained was also subjected to a hydrophobicity test by measuring the water contact angle of the sample at an initial time TO (FIG. 12C) and after 20 minutes (FIG. 12D). Also in this case, the water droplet maintains an almost spherical shape, i.e. it does not tend to settle and thus penetrate the sample material.

The test shows that the leather sample obtained through this example is hydrophobic, contact angle >90°, and that this property is maintained over time.

### Example 7

A first solution is prepared by mixing 23.6 g of epoxidized linseed oil (ELO) and 31.2 g of trimer acid (trade name: Pripol 1040), the compounds are mixed until completely homogenised. The first solution obtained was diluted in ethyl acetate to form a second solution with a 15% (w/w) concentration of ESO in ethyl acetate.

This second solution was poured into a container and a sample of cotton fabric was immersed in the second solution and kept immersed in the solution for an interval of approximately 60 seconds.

The cotton fabric sample was removed from the container and subjected to drying under a fume hood until the solvent (ethyl acetate) had completely evaporated. For this purpose, the sample of cotton fabric provided with the second solution was placed under a fume hood for a sufficient time to obtain evaporation of the solvent. After the drying step, a sample of covered cotton fabric was obtained.

This resulted in a composite material with a cotton fabric substrate onto which a film of the first solution is applied. Subsequently, the covered substrate was subjected to a cross-linking step.

For this purpose, the cotton fabric sample was placed in an oven and kept at a temperature of approximately 80° C. for a period of approximately 2 weeks.

The sample of cotton fabric obtained is shown in FIG. 13A.

This sample was subjected to FTIR analysis, the spectrum of which is shown in FIG. 138. This spectrum shows the presence of the functional groups of both the cotton fabric substrate and the compounds forming the covering.

The sample obtained was also subjected to a hydrophobicity test by measuring the water contact angle of the sample at an initial time TO (FIG. 13C) and after 20 minutes (FIG. 13D). Again, the test shows that the cotton fabric sample obtained through this example is hydrophobic, contact angle >90°, and that this property is maintained over time. In fact, the water droplet maintains an almost spherical shape, i.e. it does not tend to settle and thus penetrate the sample material.

### Example 8

A first solution is prepared by mixing 23.6 g of epoxidized linseed oil (ELO) and 31.2 g of trimer acid (trade name: Pripol 1040), the compounds are mixed until completely homogenised. The first solution obtained was diluted in ethyl acetate to form a second solution with a 15% (w/w) concentration of ESO in ethyl acetate.

This second solution was poured into a container and a sample of fish leather was immersed in the second solution and kept immersed in the solution for an interval of approximately 60 seconds. The fish leather sample was taken out of the container and subjected to drying under a fume hood until the solvent (ethyl acetate) had completely evaporated. For this purpose, the sample of fish leather provided with the second solution was placed under a fume hood for a sufficient time to obtain evaporation of the solvent. After the drying step, a sample of covered fish leather was obtained.

This resulted in a composite material with a fish leather substrate onto which a film of the first solution is applied. Subsequently, the covered substrate was subjected to a cross-linking step.

For this purpose, the fish leather sample was placed in an oven and kept at a temperature of approximately 80° C. for a period of approximately 2 weeks.

The fish leather sample obtained is shown in FIG. 14A.

This sample was subjected to FTIR analysis, the spectrum of which is shown in FIG. 14B. This spectrum shows the presence of the functional groups of both the fish leather substrate and the compounds forming the covering.

The sample obtained was also subjected to a hydrophobicity test by measuring the water contact angle of the sample at an initial time TO (FIG. 14C) and after 20 minutes (FIG. 14D). The test shows that the leather sample obtained through this example is hydrophobic, contact angle >90°, and that this property is maintained over time; in fact, a drop of water maintains an almost spherical shape, i.e. it does not tend to settle and thus penetrate the sample material.

### Example 9

A mixture is prepared by mixing 27.1 g of epoxidized linseed oil (ELO) and 22.9 g of trimer amine (trade name Priamine 1071. The compounds are mixed until completely homogenised. The first solution obtained was diluted in ethyl acetate to form a second solution with a 15% (w/w) concentration of ESO in ethyl acetate.

This second solution was poured into a container and a sample of cotton fabric was immersed in the second solution and kept immersed in the solution for an interval of approximately 60 seconds.

The cotton fabric sample was removed from the container and subjected to drying under a fume hood until the solvent (ethyl acetate) had completely evaporated. For this purpose, the sample of cotton fabric provided with the second solution was placed under a fume hood for a sufficient time to obtain evaporation of the solvent. After the drying step, a sample of covered cotton fabric was obtained.

This resulted in a composite material with a cotton fabric substrate onto which a film of the first solution is applied. Subsequently, the covered substrate was subjected to a cross-linking step.

For this purpose, the cotton fabric sample was placed in an oven and kept at a temperature of approximately 80° C. for a period of approximately 2 weeks.

The sample of cotton fabric obtained is shown in FIG. 15A.

This sample was subjected to FTIR analysis, the spectrum of which is shown in FIG. 158. This spectrum shows the presence of the functional groups of both the cotton fabric substrate and the compounds forming the covering.

The sample obtained was also subjected to a hydrophobicity test by measuring the water contact angle of the sample at an initial time TO (FIG. 15C) and after 20 minutes (FIG. 15D). Also in this case, the water droplet maintains an almost spherical shape, i.e. it does not tend to settle and thus penetrate the sample material. Therefore, the test shows that the cotton fabric sample obtained through this example is hydrophobic, contact angle >90°, and that this property is maintained over time.

### Example 10

A mixture is prepared by mixing 15.8 g of epoxidized linseed oil (ELO) and 22.9 g of trimer amine (trade name Priamine 1071) until completely homogenised. The first solution obtained was diluted in ethyl acetate to form a second solution with a 15% (w/w) concentration of ESO in ethyl acetate.

This second solution was poured into a container and a sample of cotton fabric was immersed in the second solution and kept immersed in the solution for an interval of approximately 80 seconds.

The cotton fabric sample was removed from the container and subjected to drying under a fume hood until the solvent (ethyl acetate) had completely evaporated. For this purpose, the sample of cotton fabric provided with the second solution was placed under a fume hood for a sufficient time to obtain evaporation of the solvent. After the drying step, a sample of covered cotton fabric was obtained.

This resulted in a composite material with a cotton fabric substrate onto which a film of the first solution is applied. Subsequently, the covered substrate was subjected to a cross-linking step.

For this purpose, the cotton fabric sample was placed in an oven and kept at a temperature of approximately 80° C. for a period of approximately 2 weeks.

The leather sample obtained is shown in FIG. 16A.

This sample was subjected to FTIR analysis, the spectrum of which is shown in FIG. 168. This spectrum shows the presence of the functional groups of both the cotton fabric substrate and the compounds forming the covering.

The sample obtained was also subjected to a hydrophobicity test by measuring the water contact angle of the sample at an initial time TO (FIG. 16C) and after 20 minutes (FIG. 16D). The test shows that the cotton fabric sample obtained through this example is hydrophobic, contact angle >90°, and that this property is maintained over time. In fact, also in this case, the water droplet maintains an almost spherical shape, i.e. it does not tend to settle and thus penetrate the sample material.

The samples prepared according to EXAMPLES 1-10 and the sample obtained in the COMPARATIVE EXAMPLE were subjected to certain analyses as explained below.

In order to verify the impermeability of the composite materials obtained by means of the invention, the contact angle of these composite materials was measured, and in particular the trend of the contact angle over time. The contact angle is a thermodynamic quantity described by the angle formed by the meeting of a liquid-vapour interface with a liquid-solid interface or, less typically, a liquid-liquid interface. The contact angle is generally measured to determine the wettability of a surface. By convention, hydrophobic surfaces are defined as surfaces having a contact angle with water greater than 90°.

The results of these experiments are shown in the graph in FIGS. 5 and 7 and in FIGS. 11C-D, 12C-D, 13C-D, 14C-D, 15C-D, 16C-D and the graph in FIG. 17.

In particular, FIGS. 5 and 7 show the results for the following samples:
71 indicates a sample of untreated salmon leather,
72 indicates a sample made according to Example 4, wet with PESO15 solution,
73 indicates a Teflon sample,
74 indicates a salmon leather sample obtained according to the COMPARATIVE Example,
75 indicates a sample made according to Example 1, wet with PESO1 solution,
76 indicates a sample made according to Example 2, wet with PESO5 solution,
77 indicates a sample made according to Example 3, wet with PESO10 solution.

The experiments show a very rapid decrease in the contact angle for the untreated substrate, 71. In the other three samples 72-74 the contact angle decreases over time but more slowly. Furthermore, the three samples 72-74 have consistently higher contact angle values than the untreated material. Furthermore, the contact angle of the substrate 72 obtained according to the invention is greater than that of Teflon (73) and also of the PESO film sample 74. After 40 minutes, the Teflon sample 72 and the Teflon sample 73 exhibit substantially the same contact time, i.e. a material obtained according to the invention has characteristics comparable to those of a highly waterproof material. Analyses showed that the PESO15 solution protected the leather from water absorption for up to 40 minutes, maintaining hydrophobic behaviour. The untreated fish leather, 71 had a faster absorption of water. Furthermore, the data show that the contact angle is greater in the salmon leather samples provided with the covering than in the covering film alone, even when cross-linked. This highlights good synergy between the functional groups of the substrate and the first compound and high stability of the bonds formed.

Furthermore, tests show that as the solvent in the second solution increases the covering's ability to protect the substrate from water absorption also increases.

Tests on samples from Examples 5-10 show that the samples obtained are hydrophobic and that this property is maintained over time. In particular, tests show that the covering allows the substrate to be protected for an even longer time, 20 min.

The graph shown in FIG. 17 shows the contact angle measurements for the following samples:
ESO-Pripol on wool: sample made according to EXAMPLE 5;
ESO-Pripol on leather sample made according to EXAMPLE 6;
ELO-Pripol on cotton: sample made according to EXAMPLE 7;
ELO-Priamine on leather sample made according to EXAMPLE 8;
ELO-Priamine on cotton: sample made according to EXAMPLE 9;
Esterified fatty acids-Pripol on cotton: sample made according to EXAMPLE 10.

This graph clearly shows that all substrates used, after application of the covering according to the invention, exhibit high hydrophobicity with contact angles 6 with water greater than 90°. All the coverings developed with different combinations of first and second compound produce a long-lasting hydrophobic covering on different substrates.

The water absorption by substrates 71, 72, 74-77 at various relative humidity conditions was then measured: 11%, 44%, 84% and 100%. The results of these tests are collected in FIG. 7. These experiments show that samples 71 and 72 absorb much more water than salmon leather samples treated according to the invention and also more than the amount of water absorbed by the samples obtained according to Comparative Example 1.

These experiments show that the difference in the concentration of solvent, and thus of the first compound and second compound, in the second solutions prepared does not affect the water absorption capacity of the obtained sample.

FIG. 8 shows for samples 71, 72, 75, 76, 77 the Water Vapour Transmission Rate (WVTR), bar on the left, and the Water Vapour Permeability (WVP), bar on the right. The data collected in this graph show that the treatment according to the invention affects water vapour permeability but not the breathability of the substrate. The breathability of the substrate was maintained. In other words, even if a covering according to the invention is applied to the fish leather, the breathability of the composite material obtained is substantially the same as that of the original substrate. In fact, the breathability of untreated fish leather is essentially maintained.

FIG. 9 shows the stress-strain curves of the untreated fish leather, sample 71, of samples 72, 75-77. The graphs show that characteristic regions in a collagen stress-strain curve are visible in both sample 71 and 75. In contrast, in samples 72, 76, 77, a new linear region is detected due to the presence of more concentrated oils. The ANOVA test (p<0.05) revealed no significant difference between the samples, confirming that the covering made according to the invention does not alter the ductility of the fish leather regardless of the concentration of oils used to make the covering.

FIG. 10 is a graph representing the elongation at break of untreated fish leather samples, sample 71, of samples 72, 75-77.

These data are also shown in the table below

| | Linear 1 - | Linear 2 - |
|---|---|---|
| | Module ± | Module ± |
| Sample | d.s. (MPa) * | d.s. (MPa) * |
| 71- Untreated | — | 38.99 ± 16.93 |
| 75- PESO 1 | — | 45.97 ± 18.83 |
| 76- PESO 5 | 55.12 ± 19.45 | 61.36 ± 15.13 |
| 77- PESO 10 | 51.38 ± 30.06 | 45.89 ± 21.90 |
| 72- PESO 15 | 55.94 ± 20.08 | 41.99 ± 13.31 |

d.s.=standard deviation. The table above shows the modulus (MPa) of the two linear regions identified from the stress-strain curves of the fish leather of samples 71, 72, 75-77. The ANOVA test (p<0.05)* showed no significant differences between the samples analysed.

The samples obtained according to Examples 1-4 of the invention were analysed to assess their weight and, by means of the fraction of material that is cross-linked (gel fraction, GF), the degree of cross-linking

| Sample | Weight ± s.d. (mg) | GF ± s.d. (%) |
|---|---|---|
| 75- PESO 1 | 4.7 ± 0.7 | 98.1 ± 1.0 |
| 76- PESO 5 | 19.2 ± 3.0 | 98.9 ± 0.1 |
| 77- PESO 10 | 30.1 ± 1.7 | 97.8 ± 0.2 |
| 72- PESO 15 | 53.2 ± 2.4 | 97.3 ± 0.5 |

The table shows the weights and cross-linking efficiency of samples provided with various coverings according to the invention on the fish leather. As can be seen, the higher the PESO concentration, the greater the weight of the covering. Furthermore, the cross-linking effectiveness between the covering materials and the collagen of the substrate was evaluated in terms of gel fraction (GF). The cross-linking fraction (or gel fraction) is a representative measure of the degree of cross-linking of the composite material, i.e. the bonds between substrate/first compound/second compound and first compound/substrate. The cross-linking fraction was found to be very high, demonstrating that a very good substrate/first compound/second compound and first compound/substrate bond is formed in the composite material and that these bonds involve a high percentage of the functional groups of the substrate. These results also show that the cross-linking fraction is independent from the percentage of solvent in the second solution, i.e. the oil/mixture percentage.

Therefore, the solvent has no considerable effect on the cross-linking efficiency and formation of bonds between the covering and the substrate. The solvent changes the viscosity of the solution, affecting the methods that can be used to apply the covering to the substrate and/or the time required to effectively coat the substrate with the covering.

FIGS. 11B, 12B, 138, 14B, 15B and 168 show spectra obtained by transform infra-red spectroscopy of samples obtained according to examples 5-10, respectively. From all these spectra, one can see the characteristic peaks of both the functional groups typical of the respective substrates and the functional groups of the compounds used to make the coverings. This confirms that in the composite material obtained, the functional groups of the substrate and covering are maintained and that the application of the covering according to the invention does not compromise the structure of the substrate.

The invention therefore offers many advantages and allows for the production of waterproof and water-repellent composite materials.

The project from which this patent application is derived received funding from the European Union's Horizon 2020 research and innovation programme under the Marie Sklodowska-Curie grant agreement No 823943.

1. A method for making a composite material comprising at least one substrate and a covering layer which is applied to the substrate, the method comprising the following steps:
providing a substrate containing a plurality of functional groups which are selected from a group comprising a carboxyl group (—COOH), an amino group (—NH2), a thiol group (—RSH), a hydroxyl group (—OH) or a combination thereof,
mixing approximately from 30 to 70% by weight of a first compound with from 70 to 30% by weight of a second compound to obtain a first solution of said first compound and said second compound, wherein the first solution is homogeneous,
wherein said first compound is an epoxidized compound comprising at least 1.5 epoxide groups per molecule, and said second compound comprises a polyfunctional compound;
applying said first solution to said substrate,
subjecting said substrate to a drying step for a time period of at least approximately 30 minutes in order to dry said substrate which is provided with said first solution;
subjecting said substrate to a cross-linking step in order to cross-link the substrate by maintaining said substrate at a temperature between approximately 50° C. and approximately 90° C., for such a cross-linking time as to cause an opening reaction of at least a portion of the epoxide groups of said first compound in order to form a bond between said first compound with said second compound and said substrate in the region of at least some of the functional groups of said second compound and said substrate and a bond between said first compound and said substrate in the region of at least some of the functional groups of said substrate.

2. A method for making a composite material comprising at least one substrate and a covering layer which is applied to the substrate, the method comprising the following steps:
providing a substrate containing a plurality of functional groups which are selected from a group comprising a carboxyl group (—COOH), amino group (—NH2), thiol group (—RSH), hydroxyl group (—OH) or a combination thereof,
mixing approximately from 30 to 70% by weight of a first compound with from 70 to 30% by weight of a second compound to obtain a first solution of said first compound and said second compound, wherein the first solution is homogeneous,
wherein said first compound is an epoxidized compound comprising at least 1.5 epoxide groups per molecule, and said second compound comprises a polyfunctional compound;
adding from 0.1 to 99% by weight of a solvent to said first solution so as to obtain a second solution comprising said first compound, said second compound and said solvent,
applying said second solution to said substrate,
subjecting said substrate to a drying step in order to dry said substrate by positioning said substrate which is provided with the second solution in a hood for a time period of at least approximately 30 minutes in order to dry said substrate,
subjecting said substrate to a cross-linking step in order to cross-link the substrate by maintaining said substrate at a temperature between approximately 50° C. and approximately 90° C. for such a cross-linking time as to cause an opening reaction of at least a portion of the epoxide groups of the first compound in order to form a bond between said first compound with said second compound and said substrate in the region of at least some of the functional groups of said second compound and said substrate and a bond between said first compound and said substrate in the region of at least some of the functional groups of said substrate.

3. The method according to claim 2, wherein said solvent is selected from a group comprising ethyl acetate, 2-propanol, ethanol, said second solution containing approximately from 1% to 20% p/p of said solvent.

4. The method according to claim 1, wherein said mixing comprises mixing approximately from 40 to 60% by weight of said first compound with approximately from 60 to 40% by weight of said second compound.

5. The method according to claim 1, wherein said first compound is selected from a group comprising triglycerides, saturated triglycerides, non-saturated triglycerides, polyunsaturated triglycerides, transesterified oils, transesterified oils having two molecules of fatty acids, transesterified oils having a molecule of fatty acid, or non-esterified oils, or the admixtures thereof, and having at least 1.5 epoxide groups per molecule.

6. The method according to claim 1, wherein said second compound comprises a dimer acid and/or a trimer acid of fatty unsaturated acids or the admixtures thereof.

7. The method according to claim 1, wherein said substrate comprises a protein having a plurality of carboxyl groups (—COOH) and a plurality of amino groups (—NH₂).

8. The method according to claim 1, wherein said applying comprises immersing said substrate in said first solution for a time period sufficient to wet the substrate with said first solution.

9. A composite material comprising a substrate and a covering layer which is applied to the substrate,
wherein said substrate comprises a plurality of functional groups which are selected from a group comprising a carboxyl group (—COOH), an amino group (—NH₂), a thiol group (—RSH), a hydroxyl group (—OH) or a combination thereof,
wherein said covering layer comprises a first compound having at least 1.5 epoxide groups per molecule and a second polyfunctional compound, and
in said composite material, said first compound contains at least 1.5 hydroxyl groups per molecule, said first compound is bonded to said second compound and to said substrate in the region of at least some of the functional groups of said second compound and of said substrate and said first compound is bonded to said substrate in the region of at least some of the functional groups of said substrate.

10. The method according to claim 1, wherein said drying step comprises placing said substrate provided with said first solution in a fume hood for an interval of at least approximately 30 minutes to dry said substrate.

11. The method according to claim 1, wherein said cross-linking step comprises placing the substrate provided with the first solution in a cross-linking oven and maintaining said substrate in said cross-linking oven at a temperature comprised between approximately 50° C. and approximately 90° C.

12. A composite material comprising a substrate and a covering layer which is applied to the substrate, the composite material being obtained by means of the method according to claim 1.

13. The composite material according to claim 9, wherein said substrate comprises fish skin or plant fibers.

14. The method according to claim 2, wherein said applying comprises immersing said substrate in said second solution for a time period sufficient to wet the substrate with said second solution.

15. The method according to claim 1, wherein said second compound comprises a bifunctional or trifunctional compound selected from a group comprising bifunctional carboxylic acids, trifunctional carboxylic acids, a plurality of carboxylic acids having at least 2 or 3 carboxyl groups, dimer carboxylic acids, trimer carboxylic acids, polyfunctional amines, diamines, triamines or admixtures thereof.

16. The method according to claim 2, wherein said second compound comprises a bifunctional or trifunctional compound selected from a group comprising bifunctional carboxylic acids, trifunctional carboxylic acids, a plurality of carboxylic acids having at least 2 or 3 carboxyl groups, dimer carboxylic acids, trimer carboxylic acids, polyfunctional amines, diamines, triamines or admixtures thereof.

17. The method according to claim 1, wherein said second compound is an admixture of trimer tricarboxylic acids and dimer dicarboxylic acids.

18. The method according to claim 2, wherein said second compound is an admixture of trimer tricarboxylic acids and dimer dicarboxylic acids.

19. The method according to claim 1, wherein said first compound comprises epoxidized soybean oil (ESO) having approximately 3 epoxide groups per molecule.

20. The method according to claim 2, wherein said first compound comprises epoxidized soybean oil (ESO) having approximately 3 epoxide groups per molecule.
